(19) United States
(12) Patent Application Publication
(10) Pub. No.: US 2025/0041784 A1
(43) Pub. Date: Feb. 6, 2025

(54) CANISTER

(71) Applicant: FUTABA INDUSTRIAL CO., LTD., Okazaki-shi (JP)

(72) Inventor: Koji Iwamoto, Okazaki-shi (JP)

(21) Appl. No.: 18/776,584

(22) Filed: Jul. 18, 2024

(30) Foreign Application Priority Data
Jul. 31, 2023 (JP) 2023-124730
Jul. 31, 2023 (JP) 2023-124731
Jul. 31, 2023 (JP) 2023-124732

(51) Int. Cl. B01D 53/04; B01J 20/18; B01J 20/20; B01J 20/28; F02M 25/08

(52) U.S. Cl. CPC B01D 53/0415; B01J 20/18; B01J 20/20; B01J 20/28023; B01J 20/28028; B01J 20/28035; B01J 20/2804; F02M 25/0854; B01D 2253/102; B01D 2253/108; B01D 2253/25; B01D 2253/34; B01D 2257/702; B01D 2259/40086; B01D 2259/4516

(57) ABSTRACT

One aspect of the present disclosure provides a canister configured to adsorb and desorb fuel vapor generated in a fuel tank of a vehicle. The canister includes a charge port, a purge port, an atmosphere port, a first adsorption chamber and a second adsorption chamber directly coupled to the charge port and the purge port or indirectly coupled to the charge port and the purge port via an additional chamber, a first adsorption member housed in the first adsorption chamber, and a second adsorption member housed in the second adsorption chamber. The first adsorption member includes: an adsorption sheet formed of a fiber having properties to adsorb the fuel vapor; and granules having properties to adsorb the fuel vapor and arranged to be dispersed on a surface of or an inside of the adsorption sheet. The adsorption sheet is wound around or folded to form two or more layers.

### CROSS-REFERENCE TO RELATED APPLICATIONS

The present application claims the benefit of Japanese Patent Application No. 2023-124730, No. 2023-124731, and No. 2023-124732 each filed on Jul. 31, 2023 with the Japan Patent Office, the entire disclosures of which are hereby incorporated by reference herein.

### BACKGROUND

The present disclosure relates to a canister.

A canister that inhibits vapor fuel from being released into the atmosphere is coupled to a fuel tank of a vehicle. The canister adsorbs the vapor fuel to an adsorption member, desorbs fuel from the adsorption member with sucked air for purging, and supplies the purged fuel to an engine of the vehicle.

Known as such an adsorption member of a canister, there is an adsorption member formed by stacking two or more adsorption sheets in layers as disclosed in Japanese Patent No. 7250145.

### SUMMARY

In cases where a canister is provided with an adsorption member formed by stacking two or more adsorption sheets as described above, the adsorption sheets have pores of a uniform size, and thus the fuel vapor adsorption and desorption performances of the canister are effectively demonstrated only to fuel vapor of certain concentrations. Accordingly, when the concentration of the fuel vapor widely fluctuates, the fuel vapor may be insufficiently adsorbed.

One aspect of the present disclosure preferably provides a canister that demonstrates an adsorption effect on the fuel vapor in a wide range of concentrations.

An aspect of the present disclosure provides a canister configured to adsorb and desorb fuel vapor generated in a fuel tank of a vehicle. The canister includes: a charge port configured to take in the fuel vapor; a purge port configured to release the fuel vapor; an atmosphere port open to an atmosphere; a first adsorption chamber and a second adsorption chamber directly coupled to the charge port and the purge port, or indirectly coupled to the charge port and the purge port via an additional chamber; a first adsorption member housed in the first adsorption chamber; and a second adsorption member housed in the second adsorption chamber. The first adsorption member includes an adsorption sheet formed of a fiber having properties to adsorb the fuel vapor, and granules having properties to adsorb the fuel vapor and arranged to be dispersed on a surface of or an inside of the adsorption sheet. The adsorption sheet is wound around or folded to form two or more layers. Specifically, in the canister, one adsorption chamber of the first adsorption chamber and the second adsorption chamber is directly coupled to the charge port and the purge port, and the other adsorption chamber of the first adsorption chamber and the second adsorption chamber is indirectly coupled to the charge port and the purge port via an additional chamber.

In such a configuration, a combination of the adsorption capacity of the adsorption sheet and the adsorption capacity of the granules enables the first adsorption member to demonstrate its adsorption effect on the fuel vapor in a wide range of concentrations. In other words, the adsorption performance of the first adsorption member is adjustable by selection of the granules. In addition, the configuration enables the first adsorption member to be formed by winding or folding the adsorption sheet with the granules entangled, thus eliminating a need for use of a binder to hold the granules and to adhere the layers.

In the canister described above, the first adsorption member may include, as the granules, first granules and second granules. The first granules and the second granules are different from each other. The adsorption sheet may include a first area in which the first granules are arranged and a second area in which the second granules are arranged. This configuration makes it possible to widen the range of the fuel vapor on which the first adsorption member demonstrates tis adsorption effect. For example, the configuration makes it possible to widen the range of concentrations of the fuel vapor on which the adsorption effect is demonstrated.

In the canister described above, the adsorption sheet may include a third area in which the granules are arranged, and a fourth area in which the granules are not arranged. This configuration likewise makes it possible to widen the range of the fuel vapor on which the first adsorption member demonstrates tis adsorption effect.

In the canister described above, the adsorption sheet may be wound around to form two or more layers. This configuration facilitates formation of the first adsorption member having two or more layers.

In the canister described above, the first adsorption member may further include a core material. The adsorption sheet may be wound around the core material. This configuration makes it possible with the core material to bring adjacent layers into closer contact with each other. This reduces the gaps of the first adsorption member and thus makes it possible to inhibit passage of the fuel vapor.

In the canister described above, the first adsorption chamber may be directly coupled to the atmosphere port. This configuration enables reduction in leakage of the fuel vapor from the atmosphere port.

### BRIEF DESCRIPTION OF THE DRAWINGS

Example embodiments of the present disclosure will be described hereinafter with reference to the accompanying drawings, in which:

FIG. 1 is a schematic view of a canister according to an embodiment;

FIG. 2A is a schematic perspective view of a first adsorption member in the canister in FIG. 1;

FIG. 2B is a schematic plane view of the first adsorption member in FIG. 2A;

FIG. 3A is a schematic plane view of a first adsorption member according to an embodiment which is different from the embodiment in FIGS. 2A and 2B;

FIG. 3B is a schematic perspective view of the first adsorption member in FIG. 3A;

FIG. 4 is a schematic developed view of an adsorption sheet in the first adsorption member in FIGS. 2A and 2B;

FIG. 5A is a schematic developed view of an adsorption sheet according to an embodiment which is different from the embodiment in FIG. 4;

FIG. 5B is a schematic perspective view of a first adsorption member including the adsorption sheet in FIG. 5A;

FIG. 6A is a schematic developed view of an adsorption sheet according to an embodiment which is different from the embodiment in FIG. 4;

FIG. 6B is a schematic perspective view of a first adsorption member including the adsorption sheet in FIG. 6A;

FIG. 7A is a schematic developed view of an adsorption sheet according to an embodiment which is different from the embodiment in FIG. 4;

FIG. 7B is a schematic perspective view of a first adsorption member including the adsorption sheet in FIG. 7A;

FIG. 8 is a schematic perspective view of a first adsorption member according to an embodiment which is different from the embodiment in FIGS. 2A and 2B; and

FIG. 9 is a schematic perspective view of a first adsorption member according to an embodiment which is different from the embodiment in FIGS. 2A and 2B.

### DETAILED DESCRIPTION OF EXEMPLARY EMBODIMENTS

### 1. First Embodiment

### [1-1. Configuration]

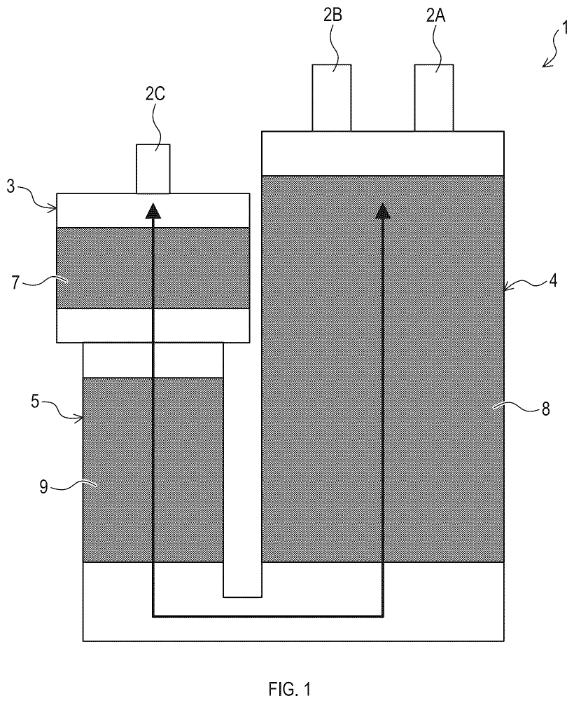

FIG. 1 shows a canister 1 which is a fuel vapor treatment device that adsorbs and desorbs fuel vapor generated in a fuel tank of a vehicle.

The canister 1 includes a charge port 2A, a purge port 2B, an atmosphere port 2C, a first adsorption chamber 3, a second adsorption chamber 4, a third adsorption chamber 5, a first adsorption member 7, a second adsorption member 8, and a third adsorption member 9.

### <Charge Port>

The charge port 2A is coupled to the fuel tank of the vehicle via a pipe. The charge port 2A is configured to take in the fuel vapor generated in the fuel tank to the inside of the canister 1.

### <Purge Port>

The purge port 2B is coupled to an air intake pipe of an engine of the vehicle via a purge valve. The purge port 2B is configured to release, from the canister 1, the fuel vapor in the canister 1 and supply the released fuel vapor to the engine.

### <Atmosphere Port>

The atmosphere port 2C is open to the atmosphere. The atmosphere port 2C releases, to the atmosphere, gas from which the fuel vapor has been removed. The atmosphere port 2C takes in external air (that is, purge air) to desorb (that is, purge) the fuel vapor adsorbed by the canister 1.

### <First Adsorption Chamber>

The first adsorption chamber 3 houses the first adsorption member 7. The first adsorption chamber 3 is directly coupled to the atmosphere port 2C without any other adsorption chamber therebetween. The first adsorption chamber 3 communicates with the atmosphere port 2C and the third adsorption chamber 5. The first adsorption chamber 3 releases, from the atmosphere port 2C, gas from which the fuel vapor has been adsorbed.

### <Second Adsorption Chamber>

The second adsorption chamber 4 houses the second adsorption member 8. The second adsorption chamber 4 is directly coupled to the charge port 2A and the purge port 2B without any other adsorption chamber therebetween. The second adsorption chamber 4 communicates with the charge port 2A, the purge port 2B, and the third adsorption chamber 5. The second adsorption chamber 4 adsorbs the fuel vapor which is taken in from the charge port 2A. The second adsorption chamber 4 releases the adsorbed fuel vapor from the purge port 2B.

### <Third Adsorption Chamber>

The third adsorption chamber 5 houses the third adsorption member 9. The third adsorption chamber 5 is arranged in a flow path of the fuel vapor between the first adsorption chamber 3 and the second adsorption chamber 4.

The fuel vapor taken in from the charge port 2A is adsorbed to the second adsorption member 8 in the second adsorption chamber 4. A portion of the fuel vapor remained un-adsorbed in the second adsorption chamber 4 flows into the third adsorption chamber 5 and is adsorbed to the third adsorption member 9 in the third adsorption chamber 5.

Further, a portion of the fuel vapor remained un-adsorbed in the third adsorption chamber 5 flows into the first adsorption chamber 3 and is adsorbed to the first adsorption member 7 in the first adsorption chamber 3. Gas from which the fuel vapor has been adsorbed is released from the atmosphere port 2C.

The fuel vapor which has been adsorbed to the first to the third adsorption members 7 to 9 respectively in the first to third adsorption chambers 3 to 5 is released to the engine from the purge port 2B as air is drawn in from the atmosphere port 2C. Accordingly, air containing the fuel vapor is supplied to the engine.

### <First Adsorption Member>

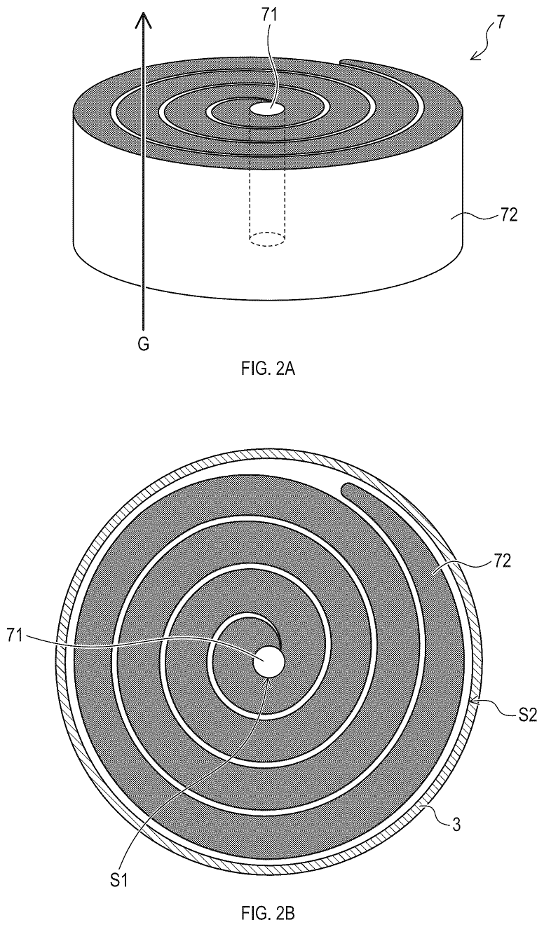

The first adsorption member 7 is housed in the first adsorption chamber 3. As shown in FIGS. 2A and 2B, the first adsorption member 7 includes a core material 71 and an adsorption sheet 72.

### <Core Material>

The core material 71 is a non-air-permeable member in a rod shape. The core material 71 is made of a material with substantially no air-permeability and has a structure that does not substantially allow passage of gas (in other words, does not have a communication hole or communication space).

The first adsorption member 7 is arranged such that an axial direction of the core material 71 is parallel to a flow direction G of the fuel vapor in the first adsorption chamber 3. In other words, in the first adsorption chamber 3, the fuel vapor flows in the axial direction of the core material 71.

As shown in FIG. 2B, the outer-circumferential surface of the core material 71 has a cross-section, which is perpendicular to the axial direction of the core material 71, in a shape (hereinafter, “first shape”) S1 similar to a shape (hereinafter, “second shape”) S2 of a cross-section of the inner-circumferential surface of the first adsorption chamber 3 perpendicular to the axial direction of the core material 71. In a case, for example, where the second shape S2 of the first adsorption chamber 3 is circular (in other words, in a case where the first adsorption chamber 3 has an internal space of a cylindrical shape), the first shape S1 of the core material 71 is also circular (in other words, the core material 71 also has a cylindrical shape).

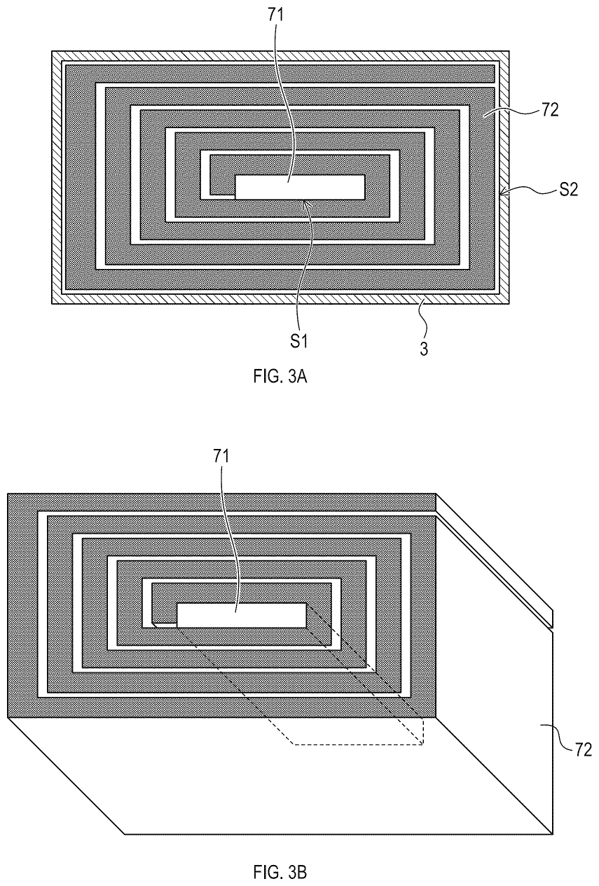

For another example, in a case where, as shown in FIG. 3A, the second shape S2 of the first adsorption chamber 3 is quadrangular (in other words, in a case where the first adsorption chamber 3 has an internal space of a quadrangular prism shape), the first shape S1 of the core material 71 is also quadrangular (in other words, the core material 71 has a quadrangular prism shape as shown in FIG. 3B).

### <Adsorption Sheet>

As shown in FIGS. 2A and 2B, the adsorption sheet 72 is wound around the core material 71. The adsorption sheet 72 has fuel vapor adsorption properties. In other words, the adsorption sheet 72 adsorbs the fuel vapor and butane supplied to the canister 1 together with air and the like. The adsorption sheet 72 desorbs the fuel vapor and butane by introduction of external air.

Specifically, the adsorption sheet 72 is formed of a fiber with fuel vapor adsorption properties. For the adsorption sheet 72, a carbon-fiber woven, knitted, or unwoven fabric, for example, can be preferably used.

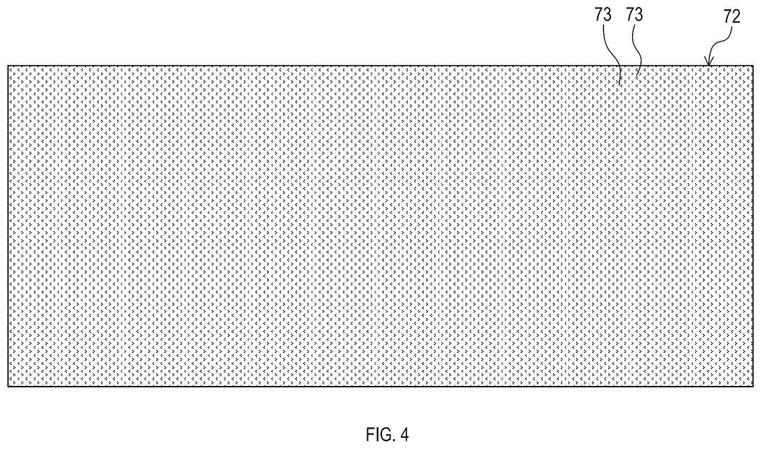

As shown in FIG. 4, the adsorption sheet 72 includes granules 73 arranged to be dispersed on the surface or the inside thereof. The granules 73 have fuel vapor adsorption properties. In other words, the first adsorption member 7 includes the granules 73 having the fuel vapor adsorption properties and arranged to be dispersed on the surface of or the inside of the adsorption sheet 72.

Examples of the granules 73 include activated carbon and zeolite. The granules 73 are positioned inside gaps between fibers (in other words, entangled with fibers) constituting the adsorption sheet 72 and thus held in the adsorption sheet 72. The adsorption sheet 72 is wound around the core material 71 with the granules 73 arranged thereon or therein. The granules 73 are arranged on or in the adsorption sheet 72 by, for example, spraying coating, or other methods.

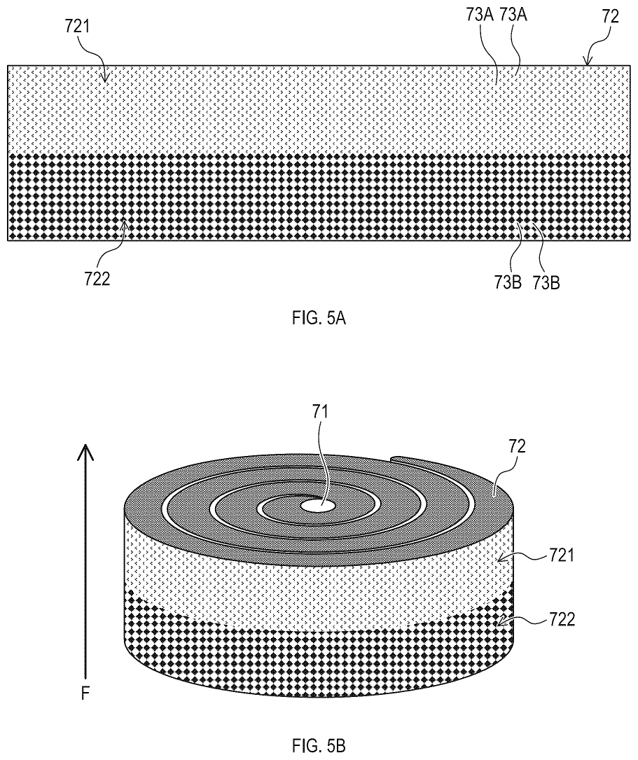

The adsorption sheet 72 and the granules 73 have adsorption performances that are different from each other. As shown in FIG. 5A, the adsorption sheet 72 may include first granules 73A and second granules 73B which are different from each other and arranged as the granules 73 on/in the adsorption sheet 72. In the case of FIG. 5A, the adsorption sheet 72 includes a first area 721 in which the first granules 73A are arranged and a second area 722 in which the second granules 73B are arranged. This configuration makes it possible to widen the range of the fuel vapor on which the first adsorption member 7 demonstrates its adsorption effect. The “range of the fuel vapor” herein may mean including the variety of concentrations, the variety of types (compositions), and so on of the fuel vapor. The expression “different from each other” used herein means being different from each other in terms of adsorption capacity and/or desorption capacity.

In the example of FIG. 5A, the adsorption sheet 72 is divided into the first area 721 and the second area 722 in a direction along a winding axis of the adsorption sheet 72 (that is, the axial direction of the core material 71). As shown in FIG. 5B, the first area 721 is located downstream of the second area 722 in a direction F in which gas in the first adsorption chamber 3 flows toward the atmosphere port 2C.

One example combination of the first granules 73A and the second granules 73B is a combination of the first granules 73A with a fuel vapor desorption capacity higher than that of the second granules 73B and the second granules 73B with a fuel vapor adsorption capacity higher than that of the first granules 73A. Alternatively, an opposite combination may be used in which the first granules 73A have a fuel vapor adsorption capacity higher than that of the second granules 73B.

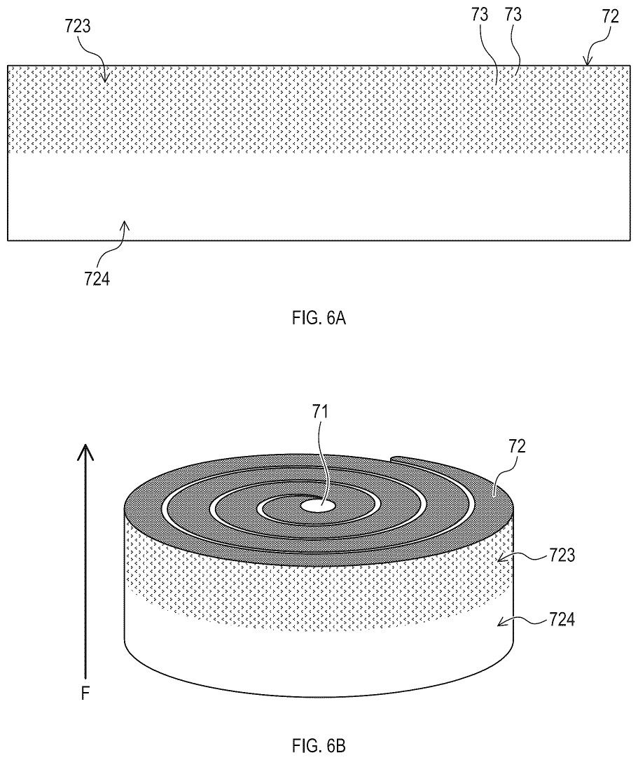

As shown in FIG. 6A, the adsorption sheet 72 may include a third area 723 in which the granules 73 are arranged and a fourth area 724 in which the granules 73 are not arranged. This configuration makes it possible to widen the range of the fuel vapor on which the first adsorption member 7 demonstrates its adsorption effect.

In the example of FIG. 6A, the adsorption sheet 72 is divided into the third area 723 and the fourth area 724 in the direction along the winding axis of the adsorption sheet 72 (that is, the axial direction of the core material 71). As shown in FIG. 6B, the third area 723 is located downstream of the fourth area 724 in the direction F.

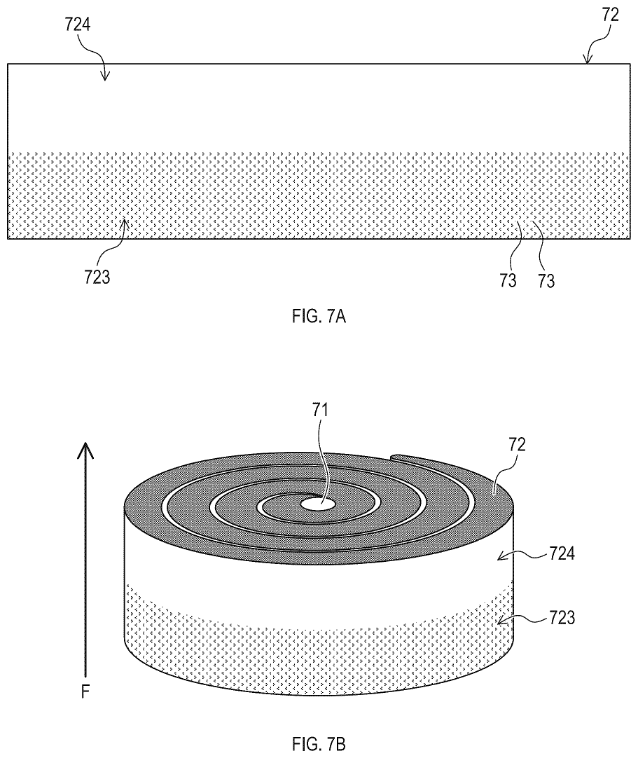

As shown in FIGS. 7A and 7B, the third area 723 may be located upstream of the fourth area 724 in the direction F.

The third area 723 may be provided with two or more types of the granules 73 arranged therein/thereon. In other words, the third area 723 may include the first area 721 and the second area 722 in which respective types of the granules 73 which are different from each other are arranged.

The adsorption sheet 72 is wound around the core material 71, forming two or more cylindrical layers. In other words, the adsorption sheet 72 in a wound state has two or more radially-stacked layers. The layers formed by the adsorption sheet 72 are arranged such that the outer-circumferential surface of inner layers is in contact with the inner-circumferential surface of the outer layers. Accordingly, there is substantially no path inside the wound adsorption sheet 72 for air to pass through in the axial direction of the core material 71.

### <Second Adsorption Member and Third Adsorption Member>

The second adsorption member 8 and the third adsorption member 9 individually adsorb the fuel vapor and butane supplied to the canister 1 together with air and the like. The second adsorption member 8 and the third adsorption member 9 desorb the fuel vapor and butane by introduction of external air.

Examples of materials that can be used for the second adsorption member 8 and the third adsorption member 9 include activated carbon and zeolite. Examples of the activated carbon include aggregates of granular activated carbon adsorbents, activated carbons formed in honeycomb shapes and the like, and fibrous activated carbons formed in sheet shapes, cubic shapes, cylindrical shapes, or polygonal-columnar shapes. The second adsorption member 8 and the third adsorption member 9 may be adsorbents of the same type or of different types. The second adsorption member 8 and the third adsorption member 9 may each include, as with the first adsorption member 7, a core material and an adsorption sheet wound around the core material.

### [1-2. Effect]

According to the embodiment described in detail hereinabove, the following effects can be achieved.

(1a) A combination of the adsorption capacity of the adsorption sheet 72 and the adsorption capacity of the granules 73 enables the first adsorption member 7 to demonstrate its adsorption effect on the fuel vapor in a wide range of concentrations. In other words, the adsorption performance of the first adsorption member 7 is adjustable by selection of the granules 73. In addition, the configuration according to the above-described embodiment enables the first adsorption member 7 to be formed by winding the adsorption sheet 72 with the granules 73 entangled, thus eliminating a need for use of a binder to hold the granules 73 and to adhere the layers.

(1b) The configuration in which the adsorption sheet 72 is wound around facilitates formation of the first adsorption member 7 having two or more layers.

(1c) The configuration in which the adsorption sheet 72 is wound around the core material 71 makes it possible with the core material 71 to bring adjacent layers of the first adsorption member 7 into closer contact with each other. This reduces the gaps of the first adsorption member 7 and thus makes it possible to inhibit passage of the fuel vapor.

(1d) The configuration in which the first adsorption member 7 is housed in the first adsorption chamber 3 coupled to the atmosphere port 2C enables reduction in leakage of the fuel vapor from the atmosphere port 2C.

### 2. Other Embodiments

An embodiment of the present disclosure has been described hereinabove. However, it goes without saying that the present disclosure is not limited to the aforementioned embodiment and may be embodied in various forms.

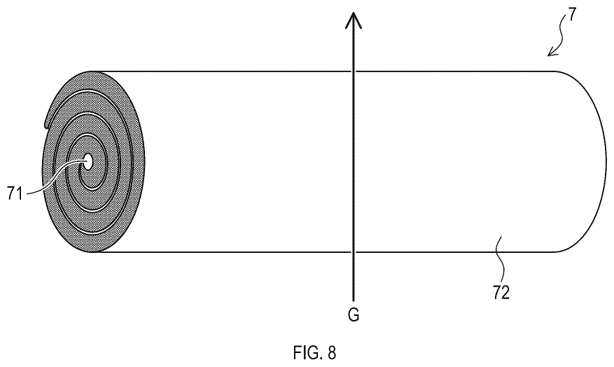

(2a) In the canister of the aforementioned embodiment, in the first adsorption chamber the fuel vapor does not necessarily have to flow in the axial direction of the core material. For example, as shown in FIG. 8, the first adsorption member 7 may be arranged such that the axial direction of the core material 71 intersects with the flow direction G of the fuel vapor in the first adsorption chamber. In this case, the core material 71 may have a hollow shape (in other words, a hollow cylindrical shape).

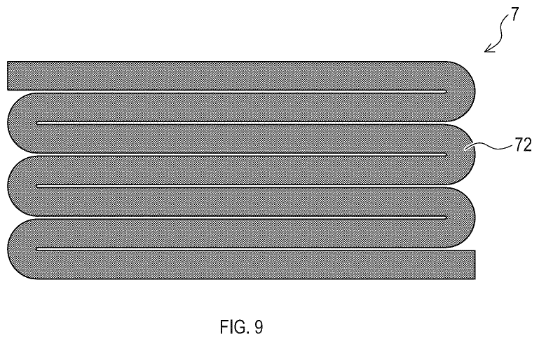

(2b) In the canister of the aforementioned embodiment, the first adsorption member does not necessarily have to include the core material. The adsorption sheet does not necessarily have to be wound around. For example, as shown in FIG. 9, the adsorption sheet 72 may be folded to form two or more layers.

(2c) In the canister of the aforementioned embodiment, the first adsorption member does not necessarily have to be housed in the first adsorption chamber coupled to the atmosphere port. The first adsorption member may be housed in, for example, an adsorption chamber coupled to a charge port and a purge port.

(2d) One or a plurality of functions of one component in the aforementioned embodiments may be distributed as a plurality of components, or one or a plurality of functions of a plurality of components may be integrated into one component. A part of the configurations of the above embodiments may be omitted. At least a part of the configurations of the above embodiments may be added to or replaced with another configuration of the above embodiments. Any and all embodiments encompassed by the technical idea defined by the language of the claims are embodiments of the present disclosure.

What is claimed is:

1. A canister configured to adsorb and desorb fuel vapor generated in a fuel tank of a vehicle, the canister comprising:
a charge port configured to take in the fuel vapor;
a purge port configured to release the fuel vapor;
an atmosphere port open to an atmosphere;
a first adsorption chamber and a second adsorption chamber directly coupled to the charge port and the purge port, or indirectly coupled to the charge port and the purge port via an additional chamber;
a first adsorption member housed in the first adsorption chamber; and
a second adsorption member housed in the second adsorption chamber,
the first adsorption member including:
an adsorption sheet formed of a fiber having properties to adsorb the fuel vapor; and
granules having properties to adsorb the fuel vapor and arranged to be dispersed on a surface of or an inside of the adsorption sheet, and
the adsorption sheet being wound around or folded to form two or more layers.

2. The canister according to claim 1,
wherein the first adsorption member includes, as the granules, first granules and second granules, the first granules and the second granules being different from each other, and
wherein the adsorption sheet includes:
a first area in which the first granules are arranged; and
a second area in which the second granules are arranged.

3. The canister according to claim 1, wherein the adsorption sheet includes:
a third area in which the granules are arranged; and
a fourth area in which the granules are not arranged.

4. The canister according to claim 1, wherein the adsorption sheet is wound around to form two or more layers.

5. The canister according to claim 4,
wherein the first adsorption member further includes a core material, and
wherein the adsorption sheet is wound around the core material.

6. The canister according to claim 1, wherein the first adsorption chamber is directly coupled to the atmosphere port.

7. The canister according to claim 2, wherein the adsorption sheet includes:
a third area in which the granules are arranged; and
a fourth area in which the granules are not arranged.

8. The canister according to claim 2, wherein the adsorption sheet is wound around to form two or more layers.

9. The canister according to claim 8,
wherein the first adsorption member further includes a core material, and
wherein the adsorption sheet is wound around the core material.

10. The canister according to claim 2, wherein the first adsorption chamber is directly coupled to the atmosphere port.
